(19) United States
(12) Patent Application Publication
(10) Pub. No.: US 2010/0060078 A1
(43) Pub. Date: Mar. 11, 2010

(54) Dual Input LDO Regulator With Controlled Transition Between Power Supplies

(75) Inventor: John Shaw, Linlithgow (GB)

Correspondence Address: BEVER HOFFMAN & HARMS, LLP;901 Campisi Way, Suite 370, Campbell, CA, 95008, US

(73) Assignee: Micrel, Incorporated, San Jose, CA (US)

(21) Appl. No.: 12/206,627

(22) Filed: Sep. 8, 2008

(51) Int. Cl. H02M 3/156

(52) U.S. Cl. 307/31

(57) ABSTRACT

A Dual Input, Single Output Low Dropout Regulator (LDO) includes two linear regulator circuits and control circuitry that produce an overlap period during change-over between a regulated supply voltage and an unregulated supply voltage wherein both supply voltages are coupled to the LDO output pin. The unregulated supply voltage is supplied, e.g., by a battery, and the regulated supply voltage is supplied from a switching-type DC-DC converter. First and second output devices are connected between the LDO output terminal and the unregulated and regulated supply voltages, respectively. The first regulator circuit causes the first output device to supply the desired regulated output voltage while the switching regulator ramps up. The regulator circuits then turn on the second output device and gradually turn off the output device, whereby the regulated output voltage transitions from the unregulated supply voltage to the regulated supply voltage is achieved without severe voltage transients.

### FIELD OF THE INVENTION

This invention relates to voltage regulators, and in particular to dual input Low Drop-Out (LDO) regulators. The invention also relates to circuits, such as PMIC devices, that include voltage regulators.

### BACKGROUND OF THE INVENTION

Power Management ICs (PMICs) are “dual mode” power management devices that produce two or more regulated output voltages generated respectively by a DC-to-DC (DC/DC) “switching” converter and one or more Low Drop-Out (LDO) regulators, and are typically used to power mobile devices.

FIG. 4 is a functional block diagram showing a MIC23060 sequenced digital PMIC device 50, produced by the assignee of the present invention, which represents a conventional PMIC device. PMIC device 50 includes a high frequency DC-DC converter 52, a dual input LDO REGULATOR 60, and sequencing control and delay generation circuit 70 that are fabricated on a semiconductor substrate using known fabrication techniques, and packaged to include several input and output pins. A raw voltage source (e.g., a battery) provides a relatively high (e.g., 5V), unregulated voltage V_{IN} on input pin 51 that is supplied to DC-DC converter 52 and to dual input LDO regulator 60. Output pin 53A conveys the V_{SW} switch control generated by DC-DC converter 52 to an external inductor and filter capacitor (not shown), which returns the relatively high (e.g., 3.3V) regulated V_{FB} voltage at pin 53B for feedback control and provide a regulated power supply for the dual input LDO regulator 60, as well as for general use. Output pin 55 carries a relatively low (e.g., 2.5V) regulated voltage V_{OUT}_{_{—}}_{LDO} generated by dual input LDO regulator 60, and output pin 57 carries an external delay signal DLY generated by delay generation circuit 70, which is utilized to coordinate operation of PMIC device 50 and an external load circuit. Input pins 58A, 58B, and 58C receive chip I/O signals S1, S2 and S3, respectively, that are transmitted to sequencing control and delay generation circuit 70, and pins 59A and 59B carry analog ground (AGND) and power ground (PGND), respectively. Internal control signals EN_SW, EN_LDOA and EN_LDOB are generated sequencing control and delay generation circuit 70 in response to chip I/O signals S1, S2 and S3 and internal logic, as described below. The MIC23060 sequenced digital PMIC device is a μCap design, operating with small ceramic output capacitors and tiny inductors for stability.

Referring to the upper portion of FIG. 4, converter 52 is a switching-type converter that receives unregulated voltage V_{IN} and control signals from sequencing control and delay generation circuit 60, converts unregulated voltage V_{IN} using known techniques to produce two relatively high regulated voltages V_{SW} and V_{FB} (e.g., 3.3V) on output pins 53A and 53B, respectively. Regulated voltage V_{FB} is the final switcher voltage on the far side of an external series inductor (not shown), which is connected between pins 53A and 53B, as per a standard switcher power supply configuration. A filter capacitor (not shown) is also normally connected between pin 53B and ground pin 59A in the standard Switcher Power supply configuration. Regulated voltage V_{FB} is monitored by the internal feedback control loop of the DC-DC converter, 52, during operation via pin 53B to maintain switcher power supply regulation using known techniques.

FIG. 5 is a simplified circuit diagram showing dual input LDO regulator 60 in additional detail, along with a related portion of sequencing control and delay generation circuit 70 that includes an enable logic circuit 75.

LDO regulator 60 includes a first regulator circuit (control loop) LDOA including a first operational amplifier (op amp) 61 and a first PMOS transistor P1, a second regulator circuit LDOB including a second op amp 63 and a second PMOS transistor P2, and a voltage divider formed by resistors R1 and R2 which are connected in series between output node 55 and ground. Referring to regulator circuit LDOA, PMOS transistor P1 is connected between unregulated supply voltage V_{IN} (pin 51 of FIG. 4) and output pin 55, and has a gate terminal connected to the output terminal of op amp 61. The inverting input terminal of op amp 61 is connected to a first reference voltage V_{REF1}, and the non-inverting input terminal of op amp 61 is connected to a node N, which is defined between resistors R1 and R2. PMOS transistor P2 of regulator circuit LDOB is connected between regulated supply voltage V_{FB} and output pin 55, and has a gate terminal connected to the output terminal of op amp 63, whose inverting input terminal is also connected to first reference voltage V_{REF1}, and whose non-inverting input terminal is also connected to node N.

During operation, regulator circuits LDOA and LDOB are controlled by enable logic circuit 75 using enable signals EN_LDOA and EN_LDOB to selectively pass one of unregulated supply voltage V_{IN} (e.g., 5V) and regulated supply voltage V_{FB} (e.g., 3.3V) to output pin 55, thereby providing the desired LDO output voltage V_{OUT}_{_{—}}_{LDO} (e.g., 2.5V) that is lower than both supply voltages V_{IN} and V_{FB}. Enable logic circuit 75 receives control signals EN_LDO and EN_DCDC, which are generated in response to chip I/O signals S1, S2 and S3, and generates enable DC-DC converter (switcher) signal EN_SW that is directed to DC-DC converter 52 (see FIG. 4), and LDO control signals EN_LDOA and EN_LDOB. The operation of LDO regulator 60 is described below with reference to the timing diagrams of FIGS. 6(A) to 6(G).

Referring to FIGS. 6(A) and 6(B), at system start up (time t0), in response to input control signal EN_LDO, enable signal EN_LDOA is asserted by enable logic 75, which causes the voltage passed by regulator circuit LDOA (FIG. 6(G)) to go high, whereby LDO output voltage V_{OUT}_{_{—}}_{LDO} establishes regulation (FIG. 6(I)). At a predetermined time t1 after LDO output voltage V_{OUT}_{_{—}}_{LDO} is established and regulated, enable logic circuit 75 receives control signal EN_DCDC (FIG. 6(C)) and asserts control signal EN_SW (FIG. 6(D)), which causes DC-DC converter 52 (FIG. 4) to begin generating DC-DC converter voltage V_{FB} at time t2 (FIG. 6(E)). When regulated DC-DC converter voltage V_{FB} comes into regulation (i.e., at time t3), enable logic 75 asserts enable signal EN_LDOB (FIG. 6(F)), causing parallel control (servo) loop LDOB to power up (FIG. 6(H)) and take control of output voltage V_{OUT}_{_{—}}_{LDO} at time t4. At the same time, to boost power management efficiency, the loop control of LDOA is powered down (i.e., control signal EN_LDOA is de-asserted), as indicated in FIGS. 6(B) and 6(G), so that regulator circuit LDOA takes no current, hence dissipating no power. Load current delivered to output pin 55 (i.e., output voltage V_{OUT}_{_{—}}_{LDO}) is now delivered through a more power efficient route via the DC-DC converter 52 and regulator circuit LDOB, where there is significantly less voltage dropped across the LDOB power PMOS transistor P2, thus greatly reducing power dissipation. On power down (time t5), control signal EN_DCDC (FIG. 6(C)) is de-asserted, causing enable logic circuit 75 to de-assert control signal EN_SW (FIG. 6(D)) at time t6, thereby causing regulated supply voltage V_{FB} (FIG. 6(E)) to drop low. At the same time, control of output LDO voltage V_{LDO}_{_{—}}_{OUT} is passed from LDOB to LDOA by re-asserting enable signal EN_LDOA (FIG. 6(B)) and de-asserting enable signal EN_LDOB (FIG. 6(F)). From this point LDO regulator 60 can be turned off completely (e.g., at time t7), or DC-DC converter 52 can be re-enabled to repeat the power up sequence detailed above.

An advantage of conventional dual input LDO regulator 60 is that it allows for a highly efficient power management solution of providing a linearly regulated output voltage from raw (unregulated) power supply V_{IN}. If unregulated supply voltage V_{IN} is much larger than the LDO output voltage V_{OUT}_{_{—}}_{LDO}, then regulator circuit LDOA alone provides an inefficient power source, so DC-DC converter 52 is utilized to efficiently step down the raw supply voltage V_{IN} to intermediate regulated voltage V_{FB}, and second regulator circuit LDOB is used to step down this lower power supply to the desired LDO output voltage V_{OUT}_{_{—}}_{LDO}, i.e., whereby efficiency is greatly improved, and the linear LDO reduces some of the switcher noise to the LDO output.

One problem associated with conventional dual input LDO regulator 60 is that, whereas system efficiency is optimized, the hand-over between regulator circuit LDOA to the more efficient regulator circuit LDOB can exhibit temporary deviation from the ideal LDO output voltage V_{OUT}_{_{—}}_{LDO} (e.g., between times t3 and t4 and between time t5 and t6 in the timing diagrams of FIGS. 6(A) to 6(I)), which can cause significant problems to noise sensitive circuitry in the load. That is, the power efficiency produced by switching the source of LDO output voltage V_{OUT}_{_{—}}_{LDO} from unregulated supply voltage V_{IN} to regulated supply voltage V_{FB} by way of regulator circuits LDOA and LDOB comes at a cost of potential disturbance of LDO loop handover switching transients injected onto the regulated LDO output voltage.

What is needed is a dual input LDO regulator and associated circuitry that addresses the power source change-over problem described above.

### SUMMARY OF THE INVENTION

The present invention is directed to a dual input LDO regulator and associated circuitry that addresses the power source change-over problem associated with conventional dual input LDO regulators by providing a supply overlap at each change-over (transition) period during which both the unregulated supply voltage and the regulated supply voltage are simultaneously passed to the output voltage terminal. For example, during the start-up change-over period, the first regulator circuit continues to pass the unregulated supply voltage to the output voltage terminal for a predetermined overlap period after the second regulator circuit begins passing the regulated supply voltage to the output voltage terminal, and then the first regulator circuit de-couples the unregulated supply voltage so that only the regulated supply voltage is passed to the output voltage terminal. Conversely, during the power-down change-over period, the second regulator circuit continues to pass the regulated supply voltage to the output voltage terminal for a predetermined overlap period after the first regulator circuit begins passing the unregulated supply voltage. By creating the overlap period during which both the regulated and unregulated power supplies are simultaneously passed to the output pin, the present invention allows the established regulator circuit to reliably maintain the output voltage until the second regulator circuit is able to settle at its DC bias point, thus avoiding temporary deviations from the ideal LDO output voltage that can cause significant problems to noise sensitive circuitry in the load. That is, because both power supplies are simultaneously coupled to the output pin, any switching transients generated by the newly coupled power supply during the change-over period are masked by the presence of the already-stable power supply, whereby the regulated output voltage remains at its required voltage level.

According to an embodiment of the present invention, the dual input LDO regulator utilizes one of a slowly ramping offset voltage and a slowly ramping control voltage (delay timer) to gradually turn off the de-selected power supply at the end of each change-over period, thereby facilitating reliable continuous control of the regulated LDO output voltage during the change-over process. For example, at the end of the start-up change-over period, after the second regulator circuit begins passing the regulated supply voltage to the output voltage terminal, the first regulator circuit utilizes one of a slowly ramping offset voltage and a slowly ramping control voltage to gradually de-couple the unregulated supply voltage from the output voltage terminal. In one embodiment, the first regulator circuit includes an output device (e.g., a PMOS transistor or bipolar transistor) that is connected between the unregulated supply voltage and the output voltage terminal, and a first control circuit (e.g., an operational amplifier) that controls the output device to produce the regulated output voltage at its required voltage level. The control circuit compares the regulated LDO output voltage with a first reference voltage, and generates an output voltage that controls the output device such that the portion of the unregulated supply voltage passed to the output voltage terminal is equal to the desired regulated output voltage. In accordance with the present embodiment, a slowly ramping equivalent input offset voltage circuit serves to selectively pass the signal from the output voltage terminal to an associated input terminal of the control circuit such that the signal on the input terminal slowly ramps up (or down) in a way that causes the control circuit to gradually turn off the output device. At the same time the second LDO regulator acquires control of the combined LDO servo loop, thereby facilitating a smooth and reliable transition of the supply used to generate the regulated LDO output voltage to the now-established regulated supply voltage. The second regulator circuit additionally includes similar circuitry to gradually de-couple the regulated supply voltage during the change-over period associated with device power down.

According to another specific embodiment of the present invention, a sequenced digital PMIC device is essentially the same in function and content as conventional PMICS, but differs in that the PMIC device of the present invention includes the dual input LDO regulator described above, and also includes sequencing control and delay generation circuit that provide the control and enable signals required for the LDO regulator to function in accordance with the present invention as described herein. That is, in addition to dual input LDO regulator, the PMIC device includes an input pin 51 for receiving the unregulated supply voltage, a DC-DC converter for generating the regulated supply voltage, and the sequencing control and delay generation circuit that generates control/enable signals for causing LDO regulator to generate the required LDO output voltage on the LDO output pin in accordance with the operations described herein.

According to yet another embodiment of the present invention, the output device of each regulator circuit is implemented using a PMOS transistor, and the LDO regulator further includes a comparator/switch arrangement for coupling the bulk of the second regulator circuit's PMOS transistor to the unregulated supply voltage during the first operating phase, and for coupling the PMOS bulk to the regulated supply voltage during the second operating phase. By changing its bulk voltage, the second regulator circuit's PMOS transistor is prevented from clamping the LDO output voltage to the regulated supply voltage through any parasitic diode paths. Additionally, reducing the reverse bias voltage of the PMOS bulk until it is the same voltage of its source allows the PMOS device layout to be smaller for a given LDO dropout voltage requirement.

An aspect of the present invention is the fact the on-board switcher in combination with the dual input LDO provide a highly power efficient solution of converting an unregulated high voltage battery supply to a low voltage, linearly regulated output. Another aspect is that the design approach is sympathetic to different needs of power-up sequencing so if a user of this design wants the switcher to apply power before the LDO then this is every bit as possible as if their power up sequence is the LDO supply then the regulator supply.

### BRIEF DESCRIPTION OF THE DRAWINGS

These and other features, aspects and advantages of the present invention will become better understood with regard to the following description, appended claims, and accompanying drawings, where:

FIG. 1 is block diagram showing a PMIC device incorporating a dual input prioritizing LDO regulator according to an embodiment of the present invention;

FIG. 2 is a simplified circuit diagram showing a dual input LDO regulator according to a specific embodiment of the present invention;

FIGS. 3(A), 3(B), 3(C), 3(D), 3(E), 3(F), 3(G), 3(H), 3(I), 3(J), 3(K), 3(L) and 3(M) are timing diagram showing various voltage levels generated in the LDO regulator of FIG. 2 during operation;

FIG. 4 is a simplified circuit diagram showing a conventional dual input LDO regulator;

FIG. 5 is block diagram showing a PMIC device including the conventional LDO regulator of FIG. 4; and

FIGS. 6(A), 6(B), 6(C), 6(D), 6(E), 6(F), 6(G), 6(H) and 6(I) are timing diagrams showing voltages generated in the LDO regulator of FIG. 5 during operation.

### DETAILED DESCRIPTION OF THE DRAWINGS

The present invention relates to an improvement in voltage regulators. The following description is presented to enable one of ordinary skill in the art to make and use the invention as provided in the context of a particular application and its requirements. As used herein, the term “connected” is used herein to describe the direct connective relationship between two circuit elements (i.e., by way of a conductive wire or trace without an intervening circuit element), and is distinguished from the term “coupled”, which indicates two circuit elements that are connected in a signal path but may be separated by zero or more electrical elements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

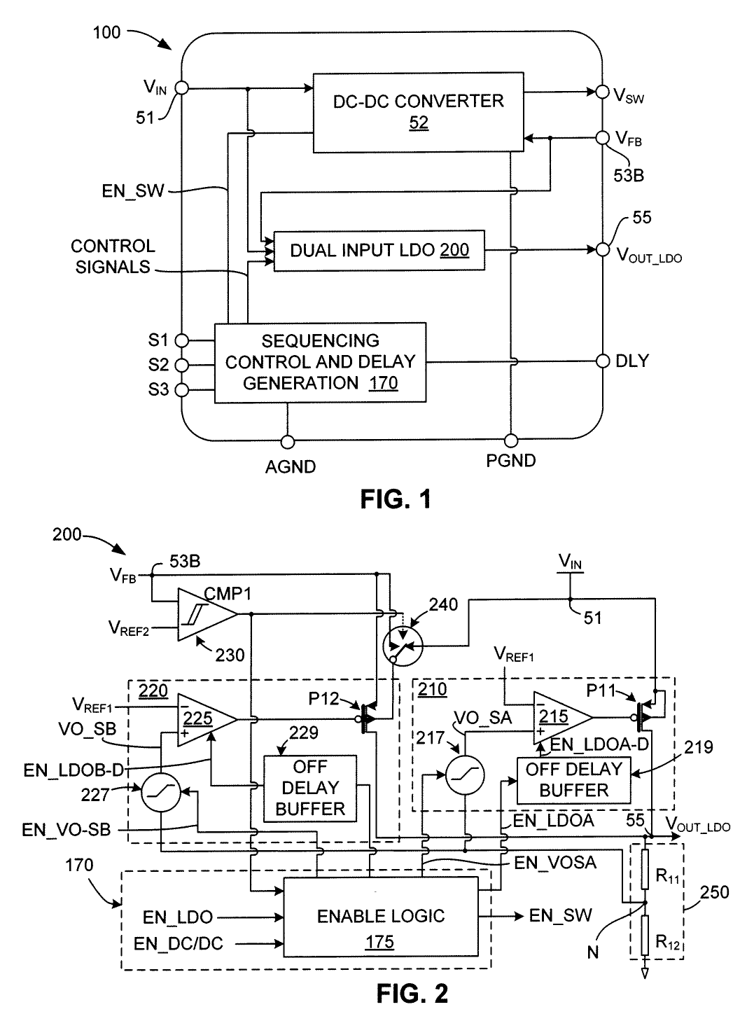

FIG. 1 is a functional block diagram showing a sequenced digital PMIC device 100 formed in accordance with an embodiment of the present invention. PMIC device 100 that is essentially the same in function and content as conventional PMIC 50 (described above), but differs in that PMIC device 100 includes a dual input LDO regulator 200 and associated sequencing control and delay generation circuit 170 that function in accordance with the present invention as described below. That is, dual input LDO regulator 200 utilizes one of an external, unregulated supply voltage V_{IN} applied at input pin (terminal) 51 and makes use of the available, lower voltage, efficiently regulated supply voltage V_{FB} generated by a conventional DC-DC buck (e.g., PWM or hysteretic) converter/regulator 52 at pin 53B to generate the required LDO output voltage V_{OUT}_{_{—}}_{LDO} on output pin 55 utilizing the control signals, described below, that are supplied from sequencing control and delay generation circuit 170. Portions of PMIC device 100 that are substantially identical to those of conventional PMIC device 50, such as DC-DC converter 52, are identified with like reference numbers, and detailed description of such portions is omitted below for brevity.

FIG. 2 is a simplified circuit diagram showing a dual input LDO regulator 200 according to an embodiment of the present invention, along with a related portion of sequencing control and delay generation circuit 170 that includes an enable logic circuit 175. LDO regulator 200 includes a first regulator circuit (control loop) 210, a second regulator circuit 220, a comparator 230, a bias control switch 240, and a voltage divider 250, which includes resistors R11 and R12 connected in series between output node 55 and ground.

First regulator circuit 210 includes a first output device (e.g., a power PMOS transistor) P11, a (first) control circuit 215, a voltage offset circuit 217, and an off delay buffer circuit 219. PMOS P11 is connected between (first) voltage input pin 51 and output voltage pin 55, and has a gate terminal connected to the output terminal of control circuit 215. Similar to the conventional LDO regulator arrangement, control circuit 215 (e.g., an operational amplifier) receives a first reference voltage V_{REF1} on its inverting input terminal, and has its non-inverting input terminal connected to a node N, which is defined between resistors R1 and R2, by way of an equivalent input voltage offset circuit 217. Voltage offset circuit 217 is an effective voltage ramp generator, but is constructed by adding a constant current in one side of the active load of the control circuit 215 so that with the existing compensation capacitors builds up a slow voltage input offset ramp voltage that slowly accumulates and causes PMOS P11 to slowly switch off, and is controlled by enable signal EN_VOSA transmitted from enable logic 175 as described below. Off delay buffer circuit 219 includes a simple current source switched into a GND connected capacitor, previously shorted by an NMOS switch to GND until EN_VOSA is asserted. When the capacitor charges to roughly half supply a Schmitt trigger inverter changes state to signal the end of the delay period, and serves to delay the transmission of conventional disable signal EN_LDOA in the manner described below, whereby a delayed signal EN_LDOA-D is applied to the power-up/power down terminal(s) of control circuit 215. The delay period can be defined by any means, either analog voltage ramp time detected by a comparator, or a Schmitt buffer, or defined digitally by counters and a clock--the important point is that a delay is defined. Note that when control circuit 215 is being enabled the off delay buffer, 219, propagates the EN_VOSA signal to control circuit 215 with no delay whereas disabling this regulator circuit, 210, the off delay buffer, 219, will produce a delay.

Second regulator circuit 220 includes a second output (e.g., power PMOS transistor) device P12, a (second) control circuit 225, a second voltage offset circuit 227, and a second off delay buffer circuit 229. PMOS P12 is connected between (second) voltage input pin 53B (i.e., the output terminal of converter 52; see FIG. 1) and output voltage pin 55, and has a gate terminal connected to the output terminal of control circuit 225. The inverting input terminal of control circuit 225 receives reference voltage V_{REF1}, and its non-inverting input terminal is connected to node N. Voltage offset circuit 227 includes an equivalent input offset voltage ramp similar to control circuit 217 in regulator circuit 210, and is controlled by enable signal EN_VOSB transmitted from enable logic 175 as described below. Off delay buffer circuit 229 is similar to circuit 219 (described above) and serves to normally enable control circuit 225, but delay the transmission of conventional disable signal EN_LDOB in the manner described below, whereby a delayed signal EN_LDOB-D is removed from the power terminal(s) of control circuit 225.

Comparator 230 and bias control switch 240 serve to detect the presence of regulated supply voltage V_{FB}, and to switch the bias applied to the body (bulk) of PMOS P12 in accordance with this detected presence. Comparator 230 utilizes known techniques to compare regulated supply voltage V_{FB} with a second reference voltage V_{REF2}, and to assert a control signal CMP1 when regulated supply voltage V_{FB} is greater than second reference voltage V_{REF2}. Switch 240 is controlled by control signal CMP1 to connect the body of PMOS transistor P12 either to unregulated supply voltage V_{IN} (e.g., when control signal CMP1 is unasserted) or to regulated supply voltage V_{FB} (e.g., when control signal CMP1 is asserted. The purpose for selectively connecting the body of PMOS transistor P12 to these different supplies is discussed further below.

During operation, similar to conventional LDO regulators, regulator circuits 210 and 220 are controlled by enable logic 175 such that, during a first operating phase (e.g., at initial power up before converter 52 is enabled), regulator circuit 210 passes unregulated supply voltage V_{IN} from voltage input pin 51 to the output voltage terminal 55, and during a second operating phase (e.g., after converter 52 has been operating long enough to stabilize regulated output voltage V_{FB}), regulator circuit 220 passes regulated supply voltage V_{FB} from voltage input pin 53B to the output voltage terminal 55. However, unlike conventional LDO regulators, during each change-over period between the first and second operating phases, regulator circuits 210 and 220 are controlled such that both unregulated supply voltage V_{IN} and regulated supply voltage V_{FB} are simultaneously passed to the output voltage terminal 55 (i.e., both PMOS transistors P11 and P12 are turned on) for a predetermined delay period. For example, during the start-up change-over period, first regulator circuit 210 continues to pass unregulated supply voltage V_{IN} to output voltage pin 55 for a predetermined overlap period (e.g., 80 microseconds after second regulator circuit 220 receives an enable signal and begins passing regulated supply voltage V_{FB} to output voltage pin 55. After the delay period defined in off delay buffer 219, first regulator circuit 210 is disabled, and de-couples the unregulated supply voltage V_{IN} by turning off PMOS transistor P1 so that only regulated supply voltage V_{FB} is passed to output voltage pin 55. Conversely, during the power-down change-over period, regulator circuit 220 continues to pass regulated supply voltage V_{FB} to output voltage pin 55 for a predetermined overlap period defined in off delay buffer 229, after regulator circuit 210 is enabled to pass unregulated supply voltage V_{IN}. By creating the overlap period during which both regulated and unregulated supply voltages V_{IN} and V_{FB} are simultaneously passed to output pin 55, the present invention facilitates reliably maintaining the regulated output voltage V_{OUT}_{_{—}}_{LDO} using the established supply (e.g., unregulated supply voltage V_{IN} during the start-up change-over period) until the second supply voltage (e.g., regulated supply voltage V_{FB} during the start-up change-over period) is able to settle at its DC bias point, thus avoiding temporary deviations from the ideal LDO output voltage that can cause significant problems to noise sensitive circuitry in the load. That is, because both supply voltages V_{IN} and V_{FB} are simultaneously coupled to voltage output pin 55 during the overlap period, any switching transients generated by one of the supply voltages during the change-over period are masked by the presence of the other supply voltage, whereby regulated output voltage V_{OUT}_{_{—}}_{LDO} remains at its required voltage level.

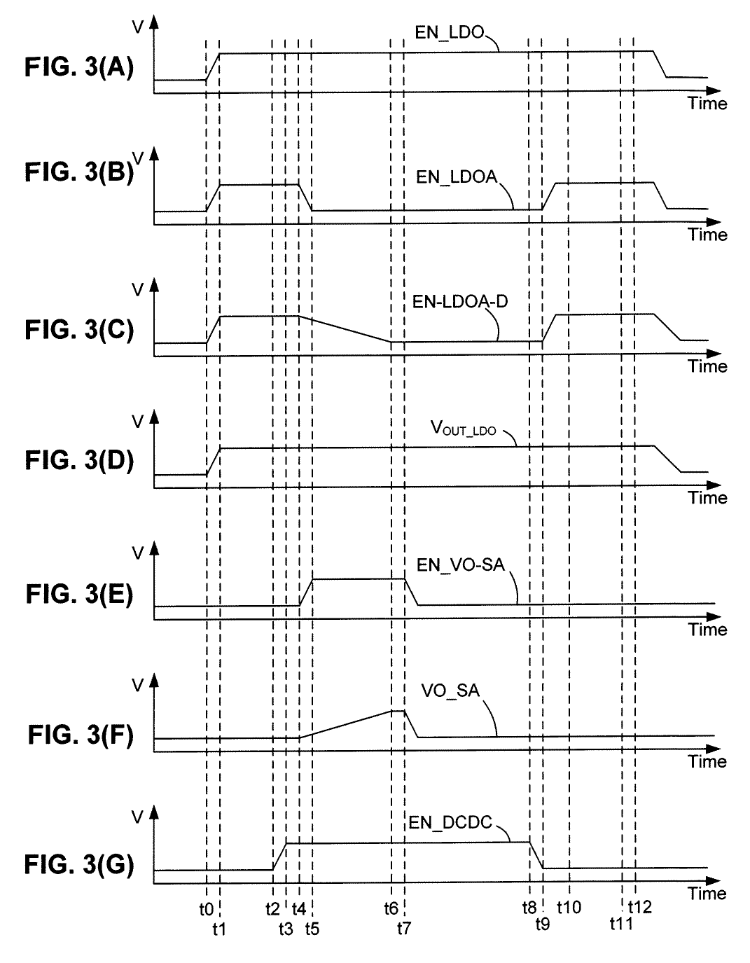

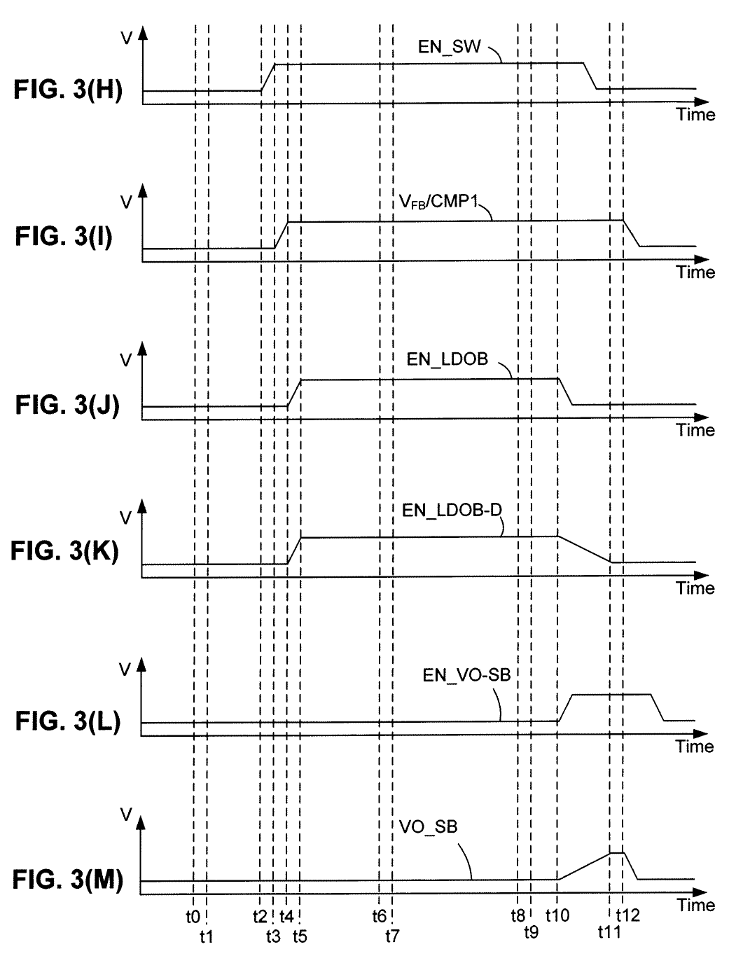

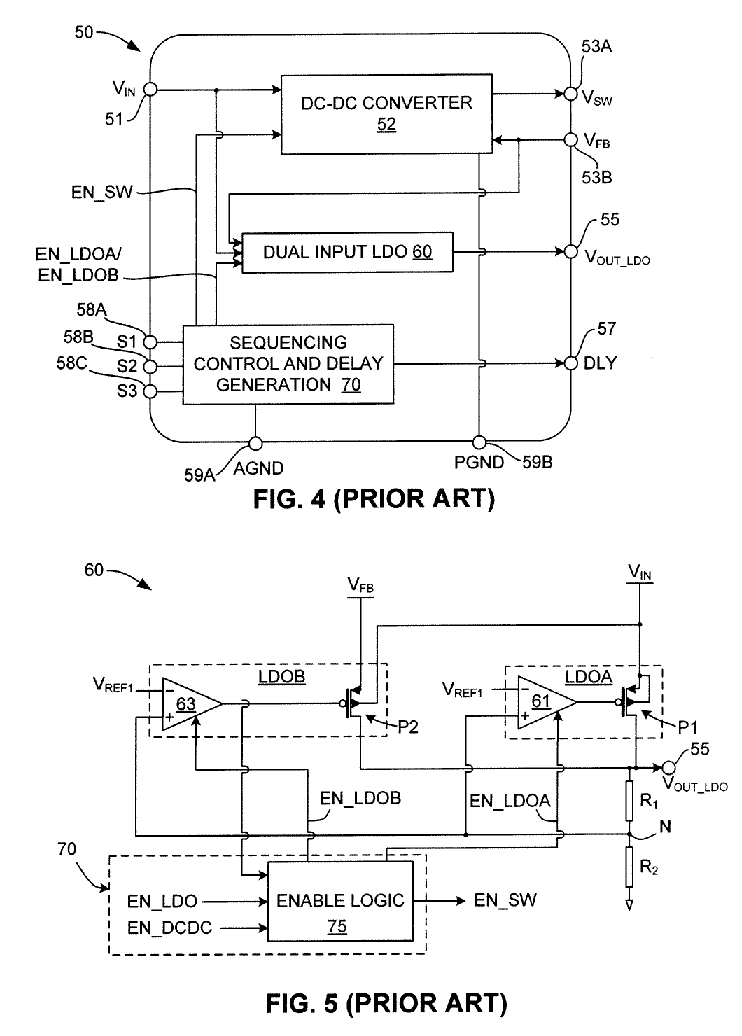

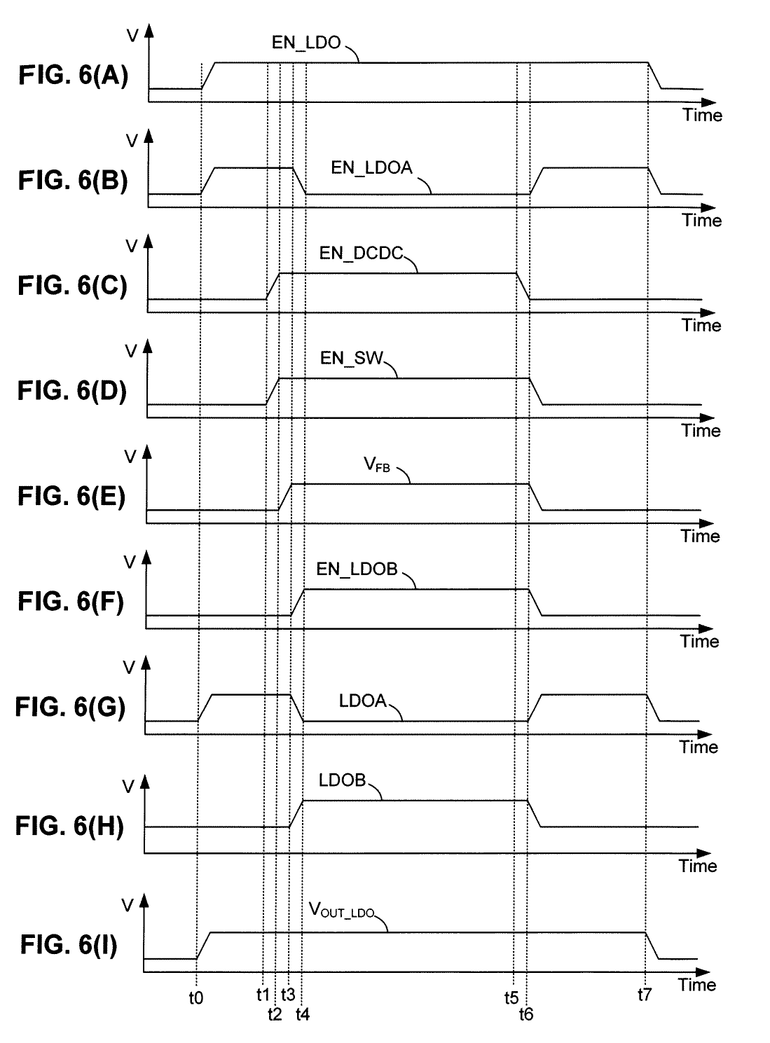

FIGS. 3(A) to 3(M) are timing diagrams that illustrate the operation of LDO regulator 200 in additional detail.

Referring to FIGS. 3(A) to 3(D), at system start up (time t0), enable logic 175 asserts enable signal EN_LDOA (FIG. 3(B)) in response to input control signal EN_LDO, which is generated in the manner described above in response to signals S1, S2 and S3 (see FIG. 1). Enable signal EN_LDOA is applied to off delay buffer circuit 219, which in response immediately propagates enable signal EN_LDOA-D, and applies delayed enable signal EN_LDOA-D to the control terminal of op amp 215. According to the present embodiment, off delay buffer circuit 219 is constructed to generate delayed enable signal EN_LDOA-D such that it effectively passes the rising edge of enable signal EN_LDOA without adding delay, other than normal switching delay (see FIG. 3(C)). Note that during the start-up and first operating phase, enable signal EN_VO-SA (FIG. 3(E)) remains low, thereby maintaining a low voltage offset signal VO-SA (FIG. 3(F)) to the non-inverting input terminal of op amp 215 (FIG. 2). In response to the applied input signals (i.e., delay enable signal EN_LDOA-D, the reference signal V_{REF1} applied to its inverting input terminal, and the zero offset VO-SA, superimposed on signal N, applied to its non-inverting input terminal), op amp 215 generates an output signal that turns on PMOS transistor P11 such that a predetermined portion of unregulated supply voltage V_{IN} is passed by PMOS transistor P11 to output node 55, whereby LDO output voltage V_{OUT}_{_{—}}_{LDO} is generated at time ti (FIG. 3(D)) having the required regulated output voltage level. The period following time t1 (i.e., when LDO output voltage V_{OUT}_{_{—}}_{LDO} is generated solely by unregulated supply voltage V_{IN}) is referred to herein as the first operating phase.

At a predetermined time t2 after LDO output voltage V_{OUT}_{_{—}}_{LDO} is established and regulated, enable logic circuit 175 receives control signal EN_DCDC (FIG. 3(G)), which marks the beginning of a first change-over period during which the source of LDO output voltage V_{OUT}_{_{—}}_{LDO} changes from unregulated supply voltage V_{IN} to regulated supply voltage V_{FS}. According to the present invention, this first change-over period involves controlling both regulator circuits 210 and 220 to briefly and simultaneously couple both unregulated supply voltage V_{IN} and regulated supply voltage V_{FB} to output voltage terminal 55 for a predetermined period of time, which is elsewhere measured by a switching regulator power good comparator to ensure regulated supply voltage V_{FB} is fully regulated before unregulated supply voltage V_{IN} is de-coupled from output voltage terminal 55.

In response to control signal EN_DCDC, enable logic asserts control signal EN_SW (FIG. 3(H)) at the beginning of the first change-over period. Control signal EN_SW causes DC-DC converter 52 (FIG. 1) to begin generating regulated supply voltage V_{FB} at time t3 (FIG. 3(I)). When regulated supply voltage V_{FB} comes into regulation (i.e., at time t4), comparator 230 asserts control signal CMP1, which is conveyed to enable logic 175 (FIG. 3(I)) and to switch 240 (see FIG. 2). In response to the assertion of control signal CMP1, enable logic 175 asserts enable signal EN_LDOB (FIG. 3(J)), de-asserts enable signal EN_LDOA (FIG. 3(C)), and turns on enable signal EN_VO-SA. As described in detail in the following paragraphs, the assertion of enable signal EN_LDOB facilitates coupling output voltage pin 55 to regulated supply voltage V_{FB}, and the de-assertion of enable signal EN_LDOA and assertion of enable signal EN_VO-SA facilitate a delayed and gradual de-coupling of output voltage pin 55 from unregulated supply voltage V_{IN}. In addition, as also described in detail below, the assertion of control signal CMP1 facilitates de-coupling the body of PMOS transistor P12 from unregulated supply voltage V_{IN} and coupling to regulated supply voltage V_{FB}.

First, the coupling of output voltage pin 55 to regulated supply voltage V_{FB} will be described. Enable signal EN_LDOB (FIG. 3(J)) is asserted beginning at time t4, which causes delay buffer circuit 229 to assert delayed enable signal EN_LDOB-D (FIG. 3(K)) that is applied to the control terminal of op amp 225 of regulator circuit 220. Similar to off delay buffer circuit 219, off delay buffer circuit 229 is constructed to generate delayed enable signal EN_LDOB-D in manner that effectively passes the rising edge of enable signal EN_LDOB without delay. Note that during this first change-over period, enable signal EN_VO-SB (FIG. 3(L)) remains low, thereby maintaining a low voltage offset signal VO-SB (FIG. 3(M)) to the non-inverting input terminal of op amp 225 (FIG. 2). In response to the applied signals, op amp 225 generates an output signal that turns on PMOS transistor P12 such that a predetermined portion of regulated supply voltage V_{FB} is passed by PMOS transistor P12 to output node 55 at time t5.

De-asserting enable signal EN_LDOA (FIG. 3(B)) and asserting enable signal EN_VO-SA (FIG. 3(E)) facilitate a delayed and gradual de-coupling of output voltage pin 55 from unregulated supply voltage V_{IN} as follows. Note that regulator circuit 220 cannot take proper control of LDO output voltage V_{OUT}_{_{—}}_{LDO} so long as regulator circuit 210 couples output voltage pin 55 to unregulated supply voltage V_{IN}. If regulator circuit 210 were disabled (i.e., if unregulated supply voltage V_{IN} were decoupled) at the beginning of the change-over period, LDO output voltage V_{OUT}_{_{—}}_{LDO} could drop out of regulation because it could still take a finite amount of settling time before regulator circuit 220 would be able to reliably source LDO output voltage V_{OUT}_{_{—}}_{LDO} at its proper operating point. To avoid the problems caused by loss of regulation during the change-over period, the overlap period is provided to allow regulator circuit 210 to continue sourcing unregulated supply voltage V_{IN} to output voltage pin 55 until regulator circuit 220 settles to its DC bias point. Although regulator circuit 210 is initially in full control of LDO output voltage V_{OUT}_{_{—}}_{LDO,} input voltage VO-SA (FIG. 3(F)) is slowly ramped up whilst delayed enable signal EN_LDOA-D remains asserted in such a way as to gently turn regulator 210 off (i.e., such that the output voltage generated by op amp 215 slowly increases to gradually turn off PMOS transistor P11) by the time the delay period matures. Note that the off delay buffer generates a logic signal, transparent when asserting on and time delayed but still logic switching speeds when de-asserting off. As PMOS transistor P11 gradually turns off, regulator circuit 220 takes up the difference in loop control until, at time t6, when signal VO-SA is maximized and delayed enable signal EN_LDOA-D finally de-asserts, regulator circuit 220 is in complete servo control of the LDO output voltage V_{OUT}_{_{—}}_{LDO} (i.e., LDO output voltage V_{OUT}_{_{—}}_{LDO} is sourced entirely by regulated output voltage V_{FB}). At time t7, a short time period after t6, enable signal EN_VO-SA is de-asserted, thus causing input signal VO-SA to drop low (note that PMOS transistor P11 remains turned off due to the low control voltage EN_LDOA-D). This process of providing an overlap period during the change-over period when both regulator circuits 210 and 220 are operating and applying a slowly increasing input offset to gradually turn off PMOS transistor P11 allows excellent continuous control of the regulated LDO output voltage V_{OUT}_{_{—}}_{LDO}.

When asserted at time t4, control signal CMP1 also activates switch 240 (SW1), which changes the bulk voltage of PMOS transistor P12 from the higher unregulated supply voltage V_{IN} to the voltage at its own source (i.e., regulated supply voltage V_{FB}). In accordance with the disclosed embodiment, dual-input LDO architecture 100 uses PMOS transistors P11 and P12 as the power-sourcing elements for the output current path. The use of PMOS transistors for this purpose can cause special problems at system power up where, without special circuitry, there is a possibility that the LDO output can find a parasitic current path through the P+ to N-type bulk diode of the PMOS transistor P12 such that both power supplies to the dual input LDO are clamped within the voltage drop of a forward biased diode. By changing the bulk voltage, PMOS transistor P12 is prevented from clamping the LDO output voltage to regulated supply voltage V_{FB} through any parasitic diode paths. Additionally, reducing the reverse bias voltage of the PMOS bulk until it is the same voltage of its source allows the PMOS device layout to be smaller for a given LDO dropout voltage requirement.

As set forth in the paragraphs above, the first change-over effectively ends at time t6, when regulator circuit 210 completely turns off PMOS transistor P11 and LDO output voltage V_{OUT}_{_{—}}_{LDO} is generated solely by regulated supply voltage V_{FB}. The period following time t6 (i.e., when LDO output voltage V_{OUT}_{_{—}}_{LDO} is generated solely by regulated supply voltage V_{FB}) until the next change-over period (e.g., the power down change-over period, described below) is referred to herein as the second operating phase.

On receiving a power down command (time t8), control signal EN_DCDC (FIG. 3(G)) is de-asserted. In response, at time t9, enable logic circuit 175 re-asserts enable signal EN_LDOA (FIG. 3(B)). Re-asserting enable signal EN_LDOA (FIG. 3(B)), with control signal EN_VO-SA de-asserted (FIG. 3(E)) causes regulator circuit 210 to re-couple unregulated supply voltage V_{IN} to voltage output pin 55 by turning on PMOS transistor P11. Second voltage offset circuit 227 and second off delay buffer circuit 229 respectively generate delayed signals VO-SB (FIG. 3(M)) and EN_LDOB-D (FIG. 3(K)) that are ramped in a manner similar to that described above such that enable signal EN_LDOB (FIG. 3(J)) disables, and asserts control signal EN_VO-SB (FIG. 3(L)), regulator circuit 220 gradually turns off PMOS transistor P12, thereby de-coupling regulated supply voltage V_{FB} from output voltage pin 55. Note that regulator circuit 210 needs to take control of the regulated output 55, V_{OUT}_{_{—}}_{LDO}, before the switcher is disabled otherwise regulated voltage supply V_{FB} may collapse before the second switchover period, which will in turn collapse regulated output V_{OUT}_{_{—}}_{LDO}. A predetermined time period later (between t10 and t11), enable logic circuit 175 de-asserts control signal EN_SW (FIG. 3(H)). De-asserting control signal EN_SW (FIG. 3(H)) causes regulated supply voltage V_{FB} (FIG. 3(I)) to drop low at time t12. Comparator circuit 230, CMP1, continuously monitors regulated supply V_{FB} and as this voltage collapses CMP1 causes switch 240 (FIG. 2) to switch the bulk of PMOS transistor P12 back to unregulated supply voltage V_{IN} but by this time full control of the LDO output, V_{OUT}_{_{—}}_{LDO} is taken up by regulator circuit 210. It should be clear that the actual switching regulator should not be disabled until regulator circuit 210 takes full control of the LDO output, V_{OUT}_{_{—}}_{LDO} otherwise V_{FB} would collapse before regulator circuit 210 has the time to source the LDO output, V_{OUT}_{_{—}}_{LDO} from unregulated supply Vᵢₙ on pin 51. From this point LDO regulator 200 can be turned off completely, or DC-DC converter 52 can be re-enabled to repeat the power up sequence detailed above.

While the present invention is described with respect to specific embodiments, those skilled in the art will recognize that other circuit structures and methods may be utilized to achieve the spirit and scope of the present invention, all of which are intended to fall within the scope of the present invention. For example, although specific delay circuits are described in association with each regulator circuit 210 and 220 this provides absolute clarification in order to illustrate the differences between the present invention and conventional LDO circuits, the functions performed by these delay circuits may be performed by enable circuit 175.

In addition, although LDO circuit 100 is described with reference to PMOS transistors P11 and P12, the function performed by these transistors may be performed using NPN bipolar transistors, and thus eliminate the need for switch 240, but this change would create a problem in that the voltage range between V_{IN} and V_{FB} would be restricted since the reverse NP diode of the bipolar transistor used as the V_{FB} pass element will break down at 5V reverse bias like a zener or avalanche diode (or at least have severe leakage current issues limiting its usefulness).

Moreover, the specific timing and switching operations described herein may be altered while remaining within the spirit and scope of the invention. Note that the DC-DC converter (switcher) 52 can be enabled by logic circuit 175 due to the S1, S2 and S3 pins high or low. In this case the switcher powers up first, and at some other point in time the LDO is powered up. Since V_{FB} is established already (due to information on CMP1) the enable logic can simply power up LDO circuit 220 and not ever need to power up circuit 210. The only subtlety here is the design of the delays and offsets need to take all this into consideration. Equally, the LDO can be disabled whilst the switcher is fully enabled and again there is no need for LDO control circuit 210 to become involved. In this way the LDO loops need to be designed to work with this flexibility.

1. A dual input low drop out (LDO) regulator for generating a regulated output voltage on an output terminal, the LDO regulator comprising:
a first regulator circuit including a first output device coupled between a first voltage input terminal and the output voltage terminal, and a first control circuit for controlling the first output device;
a second regulator circuit including a second output device coupled between a second voltage input terminal and the output voltage terminal, and a second control circuit for controlling the second output device; and
means for controlling the first and second regulator circuits such that:
during a first operating phase, the first regulator circuit passes an unregulated supply voltage from the first voltage input terminal to the output voltage terminal,
during a second operating phase, the second regulator circuit passes an regulated supply voltage from the second voltage input terminal to the output voltage terminal, and
during each change-over period between the first and second phases, both the unregulated supply voltage and the regulated supply voltage are simultaneously passed to the output voltage terminal for a predetermined delay period.

2. The dual input LDO regulator according to claim 1, wherein said means for controlling further comprises means for generating one of a slowly ramping offset voltage and a slowly ramping control voltage that control said first control circuit such that said first control circuit turns off said first output device at an end of said change-over period.

3. The dual input LDO regulator according to claim 1, wherein said means for controlling further comprises means for generating one of a slowly ramping offset voltage and a slowly ramping control voltage that control said second control circuit such that said second control circuit turns off said second output device at an end of said change-over period.

4. The dual input LDO regulator according to claim 1,
wherein the first regulator circuit comprises a first operational amplifier having a first input terminal coupled to the output voltage terminal, and a second input terminal coupled to a reference signal source, and
wherein the second regulator circuit comprises a second operational amplifier having a first input terminal coupled to the output voltage terminal, and a second input terminal coupled to the reference signal source.

5. The dual input LDO regulator according to claim 4, wherein said first regulator circuit comprises a first voltage offset circuit coupled between the output voltage terminal and the first input terminal of the first operational amplifier.

6. The dual input LDO regulator according to claim 5, further comprising a voltage divider connected between the output voltage terminal and the first voltage offset circuit.

7. The dual input LDO regulator according to claim 5, wherein said second regulator circuit comprises a second voltage offset circuit coupled between the output voltage terminal and the first input terminal of the second operational amplifier.

8. The dual input LDO regulator according to claim 4, wherein said first regulator circuit comprises a first delay buffer circuit to a control terminal of the first operational amplifier.

9. The dual input LDO regulator according to claim 4, wherein said second regulator circuit comprises a second delay buffer circuit to a control terminal of the second operational amplifier.

10. The dual input LDO regulator according to claim 1, wherein the first and second output devices are PMOS transistors.

11. The dual input LDO regulator according to claim 10, further comprising means for coupling a bulk of the second output device to the first voltage input terminal during the first operating phase, and for coupling the bulk of the second output device to the second voltage input terminal during the second operating phase.

12. A Power Management IC (PMIC) comprising:
a first voltage terminal for receiving an unregulated supply voltage having a first voltage level;
a regulated power source coupled to the first voltage input terminal for generating a regulated supply voltage on a second voltage terminal, the regulated supply voltage having a second voltage level that is lower than the first voltage level;
a dual input low drop out (LDO) regulator for generating a regulated output voltage on an output terminal, the LDO regulator comprising:
a first regulator circuit including a first output device coupled between the first voltage terminal and the output voltage terminal, and a first control circuit for controlling the first output device;
a second regulator circuit including a second output device coupled between the second voltage terminal and the output voltage terminal, and a second control circuit for controlling the second output device; and
means for controlling the first and second regulator circuits such that:
during a first operating phase, the first regulator circuit passes the unregulated supply voltage from the first voltage input terminal to the output voltage terminal,
during a second operating phase, the second regulator circuit passes the regulated supply voltage from the second voltage input terminal to the output voltage terminal, and
during each change-over period between the first and second phases, both the unregulated supply voltage and the regulated supply voltage are simultaneously passed to the output voltage terminal for a predetermined delay period.
